(19) United States
(12) Patent Application Publication
(10) Pub. No.: US 2026/0175492 A1
(43) Pub. Date: Jun. 25, 2026

(54) PREFORM OF A PLASTIC CONTAINER AND CORRESPONDING INJECTION MOLD

(71) Applicant: S.I.P.A SOCIETÁ INDUSTRIALIZZAZIONE PROGETTAZIONE E AUTOMAZIONE S.P.A, Vittorio Veneto (IT)

(72) Inventors: Marco BRUSADIN, Pordenone (IT); Tiziano PIZZINAT, Cordignano (IT); Matteo ZOPPAS, Vittorio Veneto (IT)

(21) Appl. No.: 19/121,393

(22) PCT Filed: Oct. 19, 2023
(86) PCT No.: PCT/IB2023/060562

§ 371 Date: Apr. 15, 2025

(30) Foreign Application Priority Data
Oct. 19, 2022 (IT) 102022000021594

(51) Int. Cl. B29C 45/33; B29B 11/14; B29C 49/06; B29C 49/12

(52) U.S. Cl. CPC B29C 45/33; B29B 11/14; B29C 49/06; B29C 49/12; B29C 2949/072; B29C 2949/26

(57) ABSTRACT

Preform (1) made of plastic material, adapted to produce, by means of stretch-blow molding, a bottle suitable for containing a sparkling beverage, such as sparkling wine, the preform defining a longitudinal axis (X) and comprising
a neck (2) having an inner diameter having a value D0 that is greater than or equal to 17 mm, and a thickness varying along the longitudinal axis (X) and with a minimum value of at least 4 mm;
a tubular body (3) arranged beneath said neck (2) and having a minimum inner diameter that is greater than or equal to 12 mm;
and a bottom (4), closing the tubular body (3) at a first end thereof, opposite to a second end thereof adjacent to the neck (2), said bottom (4) having a minimum thickness greater than or equal to 3 mm;
   wherein the tubular body (3) comprises
a first, substantially cylindrical-shaped, portion (5) proximal to the neck (2) and having a thickness of at least 4 mm, a length along the longitudinal axis (X) of at least 30 mm, and a respective outer diameter having value D1;
a second portion (6), adjacent to said first portion (5), and in which the outer diameter gradually increases with a truncated-cone shaped profile from the value D1 to a value D2; said second portion (6) having a maximum thickness of at least 6 mm and a length along the longitudinal axis (X) of at least 20 mm;
at least one further substantially cylindrical-shaped portion (7, 8, 9), arranged between said second portion (6) and the bottom (4), and having a thickness of at least 6 mm.

### FIELD OF THE INVENTION

The present invention relates to a preform made of a plastic material, adapted to produce containers on an industrial scale intended for filling with carbonated beverages, having a “champagne” type bottom, or base, in particular said preform being adapted to produce bottles for sparkling wine.

The invention also regards an injection mold for producing said preform.

### BACKGROUND ART

The design of a preform depends on the way in which it is blown and on the use of the consequent bottle, and must mainly take into account all such variables as:
the final shape of the bottle,
the inner volume thereof,
the type of liquid to be contained, which can be strongly or averagely carbonated,
the state of the liquid, the bottle being fillable with hot or cold liquid,
the use of the bottle, which can be disposable or reused and therefore refilled several times subject to recycling and sanitization.

At present, no bottles exist on the market made of plastic for sparkling wine or other carbonated beverages, the neck, body and bottom of which are esthetically similar to the classical glass bottles for sparkling wine, prosecco or champagne.

The need to develop this type of bottles, made of plastic instead of glass, originates from the fact that at least some of the raw materials for producing glass are decreasing and the relative production process is particularly energy intensive.

There are numerous problems to be overcome in order to produce such bottles made of plastic and they must be dealt with in the step of designing the corresponding preform.

For example, in order to obtain a bottle made of plastic with a “champagne” type bottom or base, it is necessary to have an optimum distribution of the material, especially in the zone of the support base, and therefore differentiated thicknesses on the walls of the bottle, and consequently differentiated thicknesses on the preform. In fact, for the mechanical strength at different pressure and temperature conditions, the bottom must have a well-specified material thickness map.

Furthermore, it is also difficult to produce a preform neck made of a plastic material capable of withstanding the force exerted internally by the cork and externally by the metal cage, after the blowing of the bottle, the filling thereof and the application of the cork and the relative metal cage on the cork and about the neck.

One further difficulty is represented by the choice of a material of the preform, which, during the cooling inside the molding cavity or when subjected to stretch-blow molding, does not tend to become dull or crystalize.

To date, all these problems have not been overcome and, thus, the need is felt to produce a preform made of a plastic material, which is capable of overcoming the aforesaid drawbacks.

### SUMMARY OF THE INVENTION

It is an object of the present invention to produce a preform made of a plastic material for producing a bottle for sparkling wine or other carbonated beverages, the neck, the body and the bottom of which are esthetically similar to a classical glass bottle for sparkling wine, prosecco or champagne.

It is another object of the present invention to produce a preform made of a plastic material with a neck adapted to withstand the force exerted internally by the cork and externally by the metal cage, after the blowing of the bottle, the filling thereof and the application of the cork and the metal cage on the cork and about the neck.

It is a further object of the present invention to produce a preform made of a plastic material with a neck and the longitudinal portions beneath the neck configured to obtain optimum uncorkability of the bottle blown from said preform and esthetically similar to a classical glass bottle for sparkling wine, prosecco or champagne.

It is a further object of the present invention to produce a preform with a tubular body and a bottom designed to obtain an optimally blown bottle, avoiding problems of the formation of the neck, e.g., possible shrinkages, and that is thermally stable, fillable with carbonated liquids, reusable and provided with a reliable “champagne” type bottom, i.e., it is stable on the support base.

It is a further object of the present invention to produce an injection mold specifically designed to produce said preform.

The present invention achieves at least one of such objects, and other objects that will be apparent in light of the present description, by means of a preform made of a plastic material that is adapted to produce, by means of stretch-blow molding, a bottle suitable for containing a sparkling beverage, such as sparkling wine, the preform defining a longitudinal axis X and comprising
a neck having an inner diameter having a value D0, greater than or equal to 17 mm and a thickness varying along the longitudinal axis X and with a minimum value of at least 4 mm;
a tubular body arranged beneath said neck and having a minimum inner diameter greater than or equal to 12 mm;
and a bottom, closing the tubular body at a first end thereof, opposite to a second end thereof adjacent to the neck, said bottom having a minimum thickness greater than or equal to 3 mm;
   in which the tubular body comprises
a first, substantially cylindrical-shaped, portion proximal to the neck and having a thickness of at least 4 mm, a length along the longitudinal axis X of at least 30 mm, and a respective outer diameter having a value D1;
a second portion, adjacent to said first portion and preferably distal from the neck, in which the outer diameter gradually increases with a truncated-cone shaped profile from value D1 to a value D2; said second portion having a maximum thickness of at least 6 mm and a length along the longitudinal axis X of at least 20 mm;
at least one further substantially cylindrical-shaped portion arranged between said second portion and the bottom, and having a thickness of at least 6 mm.

A further aspect of the invention relates to an injection mold for producing the aforesaid preform, said mold comprising a plurality of molding cavities, wherein each molding cavity is defined by the cooperation of a male component, or core insert, and by a female component comprising a neck insert, or neck ring, a cavity insert, and a gate insert;

wherein said neck insert extends along a longitudinal axis of the molding cavity so as to cover a first longitudinal portion of the molding cavity corresponding to a zone of the preform including both the aforesaid neck and the aforesaid first and second portions of the tubular body;
wherein said neck insert is provided, at the two ends, along said longitudinal axis with a first truncated-cone shaped projection and a second truncated-cone shaped projection, respectively;
wherein there is provided a first locking element for locking together the male component and the neck insert, by abutting at least with the side surface of said first truncated-cone-shaped projection;
wherein there is provided a second locking element for locking together the neck insert and the cavity insert, by abutting with the side surface of said second truncated-cone shaped projection;
wherein the length H1 of the first truncated-cone shaped projection and the length H2 of the second truncated-cone shaped projection, both measured along said longitudinal axis, satisfy the following relationship

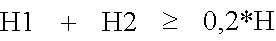

where H is the length, measured along said longitudinal axis, between a flat annular surface of the molding cavity, corresponding to the surface of the mouth of the preform, and the parting line between the neck insert and the cavity insert.

Each molding cavity is configured to obtain the aforesaid preform.

Further features and advantages of the invention will be more apparent in light of the detailed description of exemplary, but non-exclusive embodiments.

The dependent claims describe particular embodiments of the invention.

### BRIEF DESCRIPTION OF THE DRAWINGS

In the description of the invention, reference is made to the accompanying drawings, provided by way of non-limiting example, in which:

FIG. 1 represents a side view and a sectional view of a first embodiment of a preform according to the invention;

FIG. 2 represents a side view and a sectional view of a second embodiment of a preform according to the invention;

FIG. 3 represents a sectional view of a first neck variant of the preforms according to the invention;

FIG. 4 represents a sectional view of a second neck variant of the preforms according to the invention;

FIG. 5 represents a sectional view of part of an injection mold for producing preforms according to the invention;

FIG. 6 represents an example of a bottle for sparkling wine, obtained from a preform according to the invention;

FIG. 7 represents a sectional view of the “champagne”-type bottom of the bottle in FIG. 6.

The same reference numerals and letters in the figures identify the same elements or components.

### DESCRIPTION OF EXEMPLARY EMBODIMENTS OF THE INVENTION

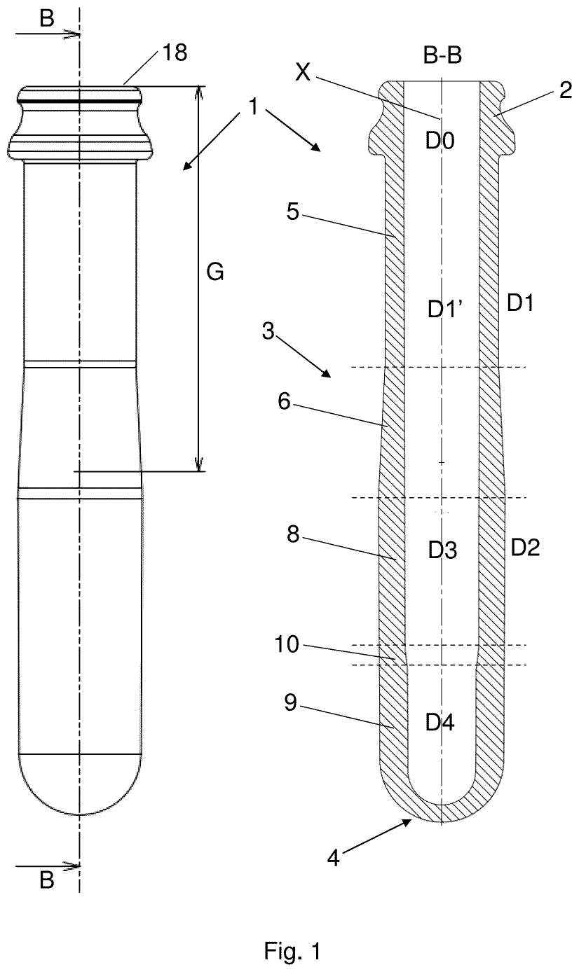

With reference to the FIGS. 1-4, some examples are shown of a preform made of a plastic material for producing a bottle for sparkling wine or other carbonated beverages, the neck, the body and the bottom of which are esthetically similar to a classical glass bottle for sparkling wine, prosecco or champagne.

In all embodiments of the invention, the preform defines a longitudinal axis X, preferably an axis of symmetry, and comprises:
a neck 2 having an inner diameter having a value D0, greater than or equal to 17 mm, and a thickness varying along the longitudinal axis X and with a minimum value of at least 4 mm;
a tubular body 3 arranged beneath the neck 2 and having a minimum inner diameter greater than or equal to 12 mm;
and a bottom 4, closing the tubular body 3 at a first end thereof, opposite to a second end thereof adjacent to the neck 2, said bottom 4 having a minimum thickness greater than or equal to 3 mm.

Advantageously, the minimum thickness of the bottom 4 ensures a suitable formation of the bottom with the “champagne”-type shape; the minimum value of the inner diameter of the tubular body 3 allows obtaining a correct blowability of the bottle with the stretch rod; and the minimum inner diameter and thickness values of the neck 2 ensure a correct insertion of the cork and adequate resistance to the force that is exerted internally by the cork and externally by the metal cage, after the blowing of the bottle, the filling thereof and the application of the cork and the metal cage on the cork and about the neck.

In this description, a “substantially cylindrical-shaped portion” means a portion of the preform that is not perfectly cylindrical as a draft angle is provided only on the inner profile, or both on the inner profile and the outer profile of the preform portion. As known, a draft angle is a conicity applied to the vertical walls of an injected molded component to assist with releasing the part from the mold.

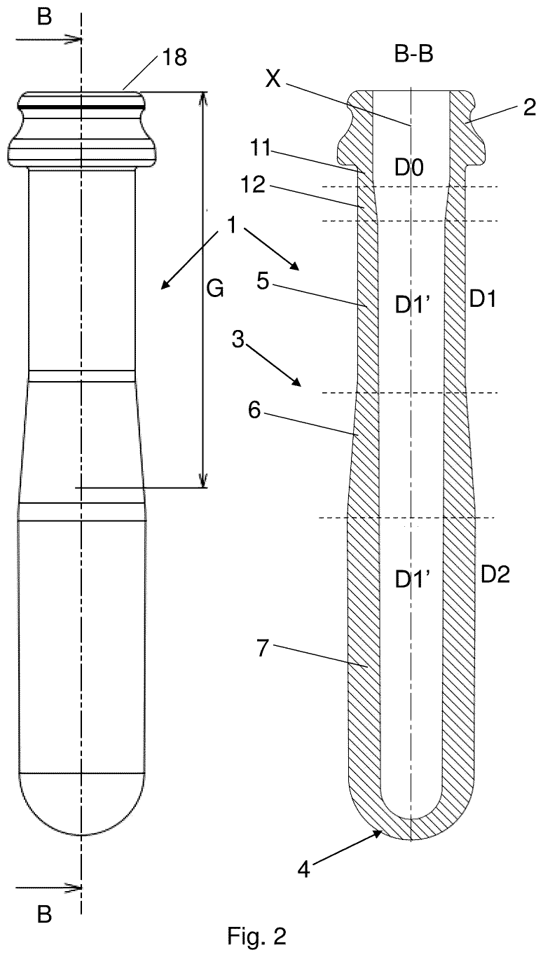

Advantageously, to ensure optimum distribution of the plastic material during the stretch-blow molding step of the bottle having a similar shape to the glass bottle for sparkling wine or prosecco or champagne, the tubular body 3 comprises (FIGS. 1 and 2)
a first, substantially cylindrical-shaped, portion 5 proximal to the neck 2 and having a thickness of at least 4 mm, a length along the longitudinal axis X of at least 30 mm, and a respective outer diameter having a value D1;
a second portion 6, adjacent to said first portion 5 and distal from the neck 2, in which the outer diameter gradually increases with a truncated-cone shaped profile from the value D1 to a value D2; said second portion 6 having a maximum thickness of at least 6 mm and a length along the longitudinal axis X of at least 20 mm;
and at least one further substantially cylindrical-shaped portion, arranged between the second portion 6 and the bottom 4, and having a thickness of at least 6 mm.

In particular, from tests carried out on uncorkability, by extracting a cork from bottles blown from the preform according to the invention and filled with a different type of sparkling wine, it has been found that an effective uncorkability, that is at least equal to the uncorkability obtained with similar-shaped glass bottles, is exclusively obtained by providing the following features of the preform, mutually combined:
the neck 2 having an inner diameter D0 that is greater than or equal to 17 mm, preferably comprised in a range from 17 to 19 mm, and a thickness varying along the longitudinal axis X and with a minimum value of at least 4 mm, preferably comprised in a range from 4 to 7 mm;
said first, substantially cylindrical-shaped portion 5, proximal to the neck 2, having a thickness of at least 4 mm, preferably from 4 to 5 mm, and a length along the longitudinal axis X of at least 30 mm, preferably comprised in a range from 30 to 50 mm;
and said second portion 6, adjacent to said first portion 5 and distal from the neck 2 with respect to the first portion 5, and having a maximum thickness of at least 6 mm and a length along the longitudinal axis X of at least 20 mm, preferably comprised in a range from 20 to 40 mm; in which the outer diameter gradually increases with a truncated-cone shaped profile from the value D1 to a value D2.

Optimum resistance both to the torsion load and the axial opening force, exerted during the uncorking, is only obtained by respecting these dimensional constraints. Whereas a deformation of the plastic bottle is obtained outside such dimensional constraints.

In a first embodiment shown in FIG. 1, the preform comprises two further substantially cylindrical-shaped portions 8, 9, arranged between the second portion 6 and the bottom 4. A first further substantially cylindrical-shaped portion 8, adjacent to the second portion 6, has a first thickness of at least 6 mm and the respective outer diameter substantially equal to value D2.

A second further substantially cylindrical-shaped portion 9, arranged between said first further substantially cylindrical-shaped portion 8 and the bottom 4, has a second thickness greater than the first thickness, preferably equal to at least 7 mm, keeping the respective outer diameter substantially equal to value D2.

The two further portions 8, 9 have a draft angle both on the outer profile and on the inner profile; while the first portion 5 has a draft angle only on the inner profile.

Such draft angle can be comprised, for example, in a range from 0° 10′ to 1°.

Preferably, the variation in thickness between the first further substantially cylindrical-shaped portion 8 and the second further substantially cylindrical-shaped portion 9 is comprised in a range from 0.2 to 1.0 mm.

In particular, said first thickness can be comprised in a range from 6 to 8.3 mm while said second thickness can be comprised in a range from 7 to 8.5 mm.

Optionally, in this first embodiment, the second portion 6 has an inner diameter that gradually decreases with a truncated-cone shaped profile from a value D1′ to the value D3, preferably said value D1′ being equal to value D0 of the inner diameter of the neck 2.

However, in this first embodiment, a connection portion 10 is always provided that connects the first further substantially cylindrical-shaped portion 8 and the second further substantially cylindrical-shaped portion 9, in which the inner diameter gradually decreases with a truncated-cone-shaped profile from a value D3 to a value D4.

If the gradual reduction of the diameter from D1′ value to D3 value is not provided in the second portion 6, in the connection portion 10 the inner diameter would gradually decrease with a truncated-cone shaped profile from value D1′ to value D4.

According to a first variant, the length of the second further substantially cylindrical-shaped portion 9 along the longitudinal axis X is at least 15 mm, preferably comprised in a range from 15 to 30 mm.

According to a second variant, the length of the first further substantially cylindrical-shaped portion 8 along the longitudinal axis X is at least 20 mm, preferably comprised in a range from 35 to 70 mm.

According to a third variant, the length of the connection portion 10 along the longitudinal axis X is at least 5 mm, preferably comprised in a range from 5 to 10 mm.

One or more dimensional ranges of the different variants of the first embodiment can also be mutually combined in one or more further variants.

In a second embodiment shown in FIG. 2, the preform comprises only one further substantially cylindrical-shaped portion 7, arranged between the second portion 6 and the bottom 4.

In this second embodiment, the further substantially cylindrical-shaped portion 7 is adjacent to the second portion 6 and has a thickness of at least 6 mm, and preferably less than 8.5 mm, and the respective outer diameter substantially equal to the value D2.

The further portion 7 has a draft angle both on the outer profile and on the inner profile; while the first portion 5 has a draft angle only on the inner profile.

Such draft angle can be comprised, for example, in a range from 0° 10′ to 1°.

In a first variant of said second embodiment, there are provided, between the neck 2 and the first portion 5:
a cylindrical stretch 11 adjacent to the neck 2 and having an inner diameter equal to D0, i.e., equal to the inner diameter of the neck, and an outer diameter equal to D1, i.e., equal to the outer diameter of the first portion 5;
and an intermediate stretch 12, connecting said cylindrical stretch 11 to the first portion 5, wherein the inner diameter of said intermediate stretch 12 gradually decreases with a truncated-cone shaped profile from value D0 to a value D1′, and wherein the outer diameter of said intermediate stretch 12 is equal to D1.

Preferably, the inner diameter of the first portion 5, of the second portion 6 and of said further cylindrical-shaped portion 7 remains substantially constant and equal to value D1′.

In this first variant of the second embodiment, the thickness of the cylindrical stretch 11 can be comprised in a range from 3 to 4 mm while the length thereof along the longitudinal axis X is less than 5 mm.

Preferably, the total length of the cylindrical stretch 11 and of the intermediate stretch 12 along the longitudinal axis X is in a range from 10 to 15 mm.

In a second variant of the second embodiment, not shown, the first substantially cylindrical-shaped portion 5 is adjacent to the neck 2 and neither the cylindrical stretch 11 nor the intermediate stretch 12 are provided. In this case, the inner diameter of the first portion 5, of the second portion 6 and of said further substantially cylindrical-shaped portion 7 remains substantially constant and equal to value D0, i.e., the inner diameter of the neck 2.

In all embodiments of the preform of the invention, to further optimize the distribution of the material during the molding step by stretch-blowing, and improve the uncorkability of the blown bottle after being filled with sparkling wine and corked, one or more of the following dimensional ranges can be provided (even all, in a preferred variant):
the length of the first portion 5 along the longitudinal axis X is comprised in a range from 30 to 50 mm, preferably from 40 to 50 mm;
the thickness of the first portion 5 is comprised in a range from 4 to 5 mm;
the length of the second portion 6 along the longitudinal axis X is comprised in a range from 20 to 40 mm;
the thickness of the bottom 4 varies in a range from 3 to 6 mm;
the minimum inner diameter of the tubular body 3 is comprised in a range from 12 to 15 mm;
the minimum thickness of the neck 2 is comprised in a range from 4 to 7 mm;
the inner diameter D0 of the neck 2 is comprised in a range from 17 to 19 mm.

Preferably, in all embodiments, considering the particularity of the final shape of the blown bottle made of plastic, the neck, body and bottom of which are similar to a classical glass bottle for sparkling wine, prosecco or champagne, the material of the preform of the invention can be selected so as to better avoid the risk of dulling and crystallization during the cooling step inside the molding cavity and during the operation of stretch-blowing. Experimentally, some materials have been considered particularly suitable.

A first material option is polyethylene furanoate (PEF), which has a barrier improvement factor, or simply BIF, equal to 8-10 for oxygen, equal to 4 for carbon dioxide, and equal to 4 for water. This choice may also not require the addition of an active or passive barrier.

A second material option is polyethylene terephthalate (PET), preferably a modified polyethylene terephthalate obtained by means of a reaction of non-hydrogenated isophthalic acid with terephthalic acid and ethylene glycol. One particularly suitable material is a modified polyethylene terephthalate providing isophthalic acid at levels of up to 7% in moles, preferably in a range from 4 to 7% in moles, replacing the terephthalic acid.

Alternatively, another suitable polyester; or a co-polyester, such as Tritan, without bisphenol; or a biopolymer with a suitable barrier improvement factor and with low crystallization speed, could be used.

In the case of using PET and filling the blown bottle with sparkling wines, at least one additive must be added to the PET, e.g., oxygen scavenger, to improve the barrier properties thereof. Sparkling wines have a maximum pressure of 3.0 bars, they contain CO₂, as well as free molecular SO₂ as a preservative, and they must be protected from oxygen getting in, for a shelf-life of 24 months.

Preferably, the selected polymeric material has an intrinsic viscosity in a range from 0.8 to 1.2 dL/g.

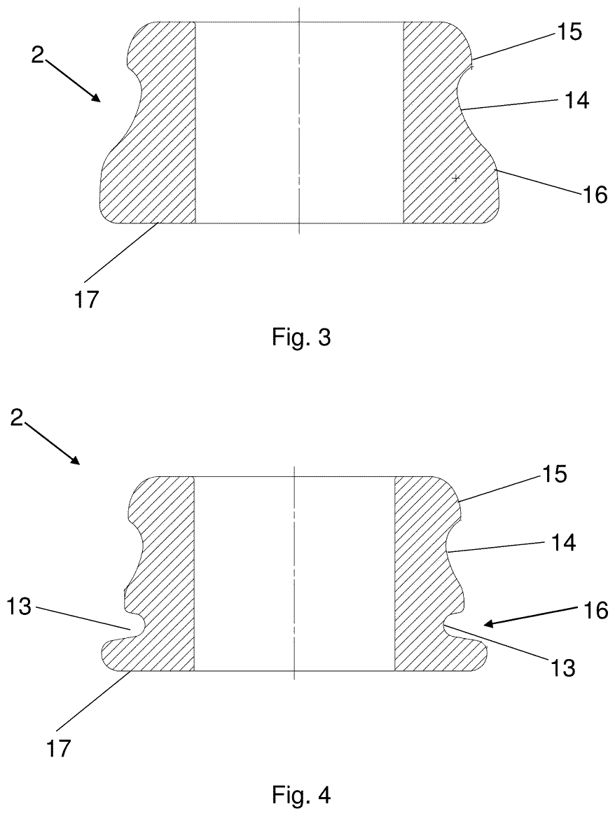

In all embodiments of the preform of the invention, the neck 2 has a profile of the outer side surface thereof along the longitudinal axis X comprising, preferably consisting of, a concave central stretch 14 arranged between two convex end stretches 15, 16 (FIG. 3).

In a variant of the neck, shown in FIG. 4, advantageously, an outer annular groove 13 is made in the end stretch 16 of the neck 2, proximal to the tubular body 3, said outer annular groove being suitable for inserting a gripper for handling the preform.

Preferably, in all embodiments of the preform, the lower surface 17 of the neck 2 is a flat surface, in particular a completely flat surface, for improving the closure of the metal cage on the neck of the bottle.

Optionally, the weight of the preform according to the invention is comprised in a range from 80 to 100 grams, preferably in a range from 85 to 95 grams.

Preferably, the center of gravity of the preform according to the invention lies, along the longitudinal axis X thereof, at a distance from the upper surface of the neck, or flat annular surface of the mouth or opening of the neck, comprised in a range from 85 to 95 mm, preferably from 88 to 92 mm. This center of gravity position also allows optimizing the formation of the blown bottle.

According to a further aspect of the invention, a specific injection mold has been designed for producing preforms on an industrial scale according to any one of the embodiments described above.

As known, the injection mold comprises a plurality of molding cavities, each cavity being suitable for molding a preform.

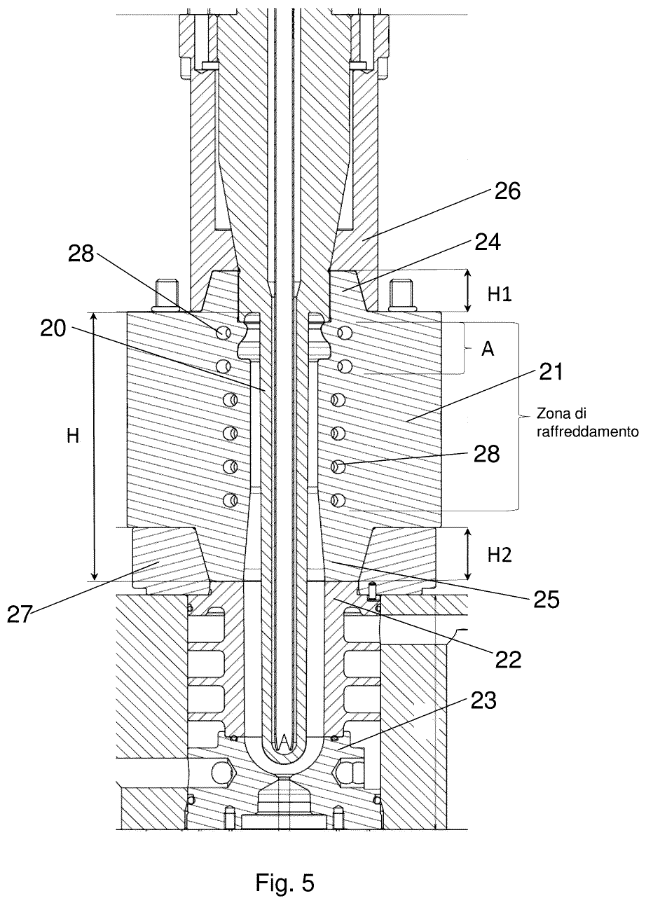

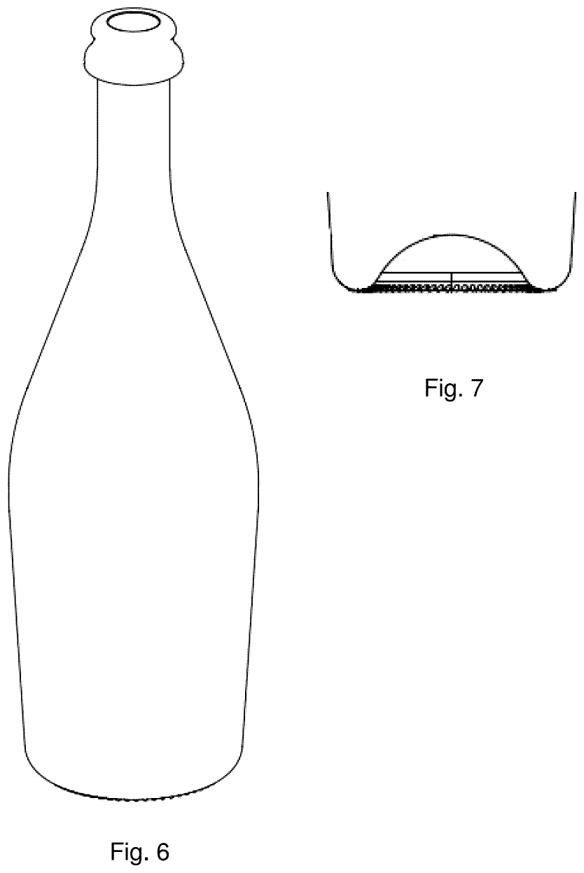

As shown in FIG. 5, each molding cavity of the mold of the invention is defined by the cooperation of a male component 20, or core insert, and a female component comprising a neck insert 21, or neck ring, a cavity insert 22, and a gate insert 23.

The shape of each molding cavity, as visible in FIG. 5, substantially corresponds to the final shape in the cold state of a preform according to the invention. The term “substantially corresponds” is justified by a possible shrinking of the material inside the molding cavity during the cooling thereof.

Advantageously, the neck insert 21 extends along a longitudinal axis of the molding cavity so as to cover a longitudinal portion of the molding cavity corresponding to a zone of the preform including both the neck 2 and the first portion 5 and the second portion 6 of the tubular body 3 of the preforms described above, i.e. it includes the zone of the preform going from the mouth or opening of the neck to the second portion 6, included, of the tubular body 3.

The neck insert 21 is provided at the two ends, considering the longitudinal axis of the cavity, with a first truncated-cone shaped projection 24 and a second truncated-cone shaped projection 25, respectively, which are coaxial to each other and to the longitudinal axis of the molding cavity and tapered in the opposite direction to each other.

Furthermore, there are also provided a first locking element 26 for locking together the male component 20 and the neck insert 21, by also abutting with the truncated-cone shaped side surface of the first truncated-cone shaped projection 24; and a second locking element 27 for locking together the neck insert 21 and the cavity insert 22, by also abutting with the truncated-cone shaped side surface of the second truncated-cone shaped projection 25.

Advantageously, to effectively contrast the elevated thrust force on the neck insert 21 due to the injection pressure and to the elevated molding surface on the neck insert itself, the length H1 of the first truncated-cone shaped projection 24 and the length H2 of the second truncated-cone shaped projection 25, both measured along the longitudinal axis of the cavity, satisfy the following relationship

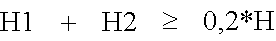

where H is the distance, measured along said longitudinal axis, between a flat annular surface of the molding cavity, corresponding to the surface of the mouth of the preform, and the parting line between the neck insert 21 and the cavity insert 22.

A further advantage can be represented by the fact of providing a plurality of cooling channels 28 inside the neck insert 21, arranged along a longitudinal portion of the molding cavity corresponding to a zone of the preform, including the neck 2 and at least the first portion 5 of the tubular body 3.

In the example in FIG. 5, the cooling channels 28 are arranged along a longitudinal portion of the molding cavity corresponding to a zone of the preform including the neck 2, the first portion 5 of the tubular body 3, and only partially the second portion 6 of the tubular body 3. In a preferred variant, it is provided that the cooling channels 28 are present along at least 70% of part of the outer profile of a longitudinal portion of the molding cavity corresponding to a zone of the preform, including both the neck 2 and the first portion 5 and second portion 6 of the tubular body 3. Compliance with this condition has been found to drastically improve transparency of the portions of the blown bottle, proximal to the neck, by keeping them in the amorphous state, without crystallizing. In fact, in particular, at least the first portion 5 of the preform is not stretched inside the mold, remaining amorphous.

Preferably, at a molding cavity portion A corresponding only to the neck of the preform, there is provided at least one cooling channel 28, e.g., one or two cooling channels, arranged at a distance, which is less than or equal to 5 mm, preferably at a distance from 2 to 3 mm, from the outer profile of said molding cavity portion A corresponding to the neck of the preform.

1. A preform made of a plastic material, adapted to produce, by means of stretch-blow molding, a bottle adapted to contain a sparkling beverage, such as sparkling wine, the preform defining a longitudinal axis and comprising
a neck having an inner diameter having a value D0 that is greater than or equal to 17 mm, and a thickness varying along the longitudinal axis and with a minimum value of at least 4 mm;
a tubular body arranged beneath said neck and having a minimum inner diameter that is greater than or equal to 12 mm;
and a bottom, closing the tubular body at a first end thereof, opposite to a second end thereof adjacent to the neck, said bottom having a minimum thickness greater than or equal to 3 mm;
wherein the tubular body comprises
a first, substantially cylindrical-shaped, portion proximal to the neck and having a thickness of at least 4 mm, a length along the longitudinal axis of at least 30 mm, and a respective outer diameter having value D1;
a second portion, adjacent to said first portion and distal from the neck, in which a respective outer diameter gradually increases with a truncated-cone shaped profile from value D1 to value D2; said second portion having a maximum thickness of at least 6 mm and a length along the longitudinal axis of at least 20 mm;
at least one further, substantially cylindrical-shaped, portion, arranged between said second portion and the bottom, and having a thickness of at least 6 mm.

2. A The preform according to claim 1, wherein said at least one further, substantially cylindrical-shaped, portion comprises
a first further substantially cylindrical-shaped portion, adjacent to said second portion and having a first thickness of at least 6 mm and a respective outer diameter substantially equal to the value D2;
a second further substantially cylindrical-shaped portion, arranged between said first further substantially cylindrical-shaped portion and the bottom and having a second thickness greater than said first thickness, equal to at least 7 mm, keeping a respective outer diameter substantially equal to value D2;
and a connection portion, connecting the first further substantially cylindrical-shaped portion and the second further substantially cylindrical-shaped portion, wherein an inner diameter gradually decreases towards the bottom with a truncated-cone-shaped profile from a value D3 to a value D4.

3. A The preform according to claim 2, wherein a variation in thickness between the first further substantially cylindrical-shaped portion and the second further substantially cylindrical-shaped portion is comprised in a range from 0.2 to 1.0 mm.

4. A The preform according to claim 2, wherein a length of said second further substantially cylindrical-shaped portion along the longitudinal axis is at least 15 mm wherein a length of said first further substantially cylindrical-shaped portion along the longitudinal axis is at least 20 mm; and wherein a length of said connection portion along the longitudinal axis is at least 5 mm.

5. The preform according to claim 2, wherein in said second portion a respective inner diameter gradually decreases towards the bottom with a truncated-cone shaped profile from a value D1′ to the value D3, wherein said value D1′ is substantially equal to value D0 of the inner diameter of the neck.

6. The preform according to claim 1, wherein there is provided only one further substantially cylindrical-shaped portion adjacent to said second portion and having a thickness of at least 6 mm and a respective outer diameter substantially equal to the value D2.

7. The preform according to claim 6, wherein, between the neck and the first portion there are provided:
a cylindrical stretch adjacent to the neck and having an inner diameter equal to D0 and an outer diameter equal to D1;
an intermediate stretch, connecting said cylindrical stretch and said first portion, and in which a respective inner diameter gradually decreases with a truncated-cone shaped profile from the value D0 to a value D1′, and a respective outer diameter is equal to D1;
wherein an inner diameter of the first portion, of the second portion and of said further cylindrical-shaped portion remains substantially constant and equal to the value D1′.

8. The preform according to claim 7, wherein a thickness of the cylindrical stretch is comprised in a range from 3 to 4 mm while a length thereof along the longitudinal axis is less than 5 mm; wherein a total length of the cylindrical stretch and of the intermediate stretch along the longitudinal axis is in a range from 10 to 15 mm.

9. The preform according to claim 1, wherein the length of the first portion along the longitudinal axis is comprised in a range from 30 to 50 mm;
wherein the thickness of said first portion is less than or equal to 5 mm;
wherein the length of the second portion along the longitudinal axis is less than 40 mm;
wherein the thickness of the bottom varies in a range from 3 to 6 mm;
wherein the thickness of the at least one further cylindrical-shaped portion is less than 8.5 mm;
wherein the minimum inner diameter of the tubular body is comprised in a range from 12 to 15 mm;
wherein the minimum value of the thickness of the neck is comprised in a range from 4 to 7 mm;
wherein the inner diameter D0 of the neck is comprised in a range from 17 to 19 mm.

10. The preform according to claim 1, made of a polymeric material selected from the following:
polyethylene furanoate (PEF);
polyethylene terephthalate (PET), modified polyethylene terephthalate obtained by means of a reaction of non-hydrogenated isophthalic acid with terephthalic acid and ethylene glycol; in particular, using isophthalic acid at levels of up to 7% in moles substituting the terephthalic acid;
another suitable polyester, at low crystallization velocity;
a co-polyester, such as Tritan, without bisphenol;
or a biopolymer with a suitable barrier improvement factor and with low crystallization velocity;
wherein said polymeric material has an intrinsic viscosity in a range from 0.8 to 1.2 dl/g.

11. The preform according to claim 1, wherein a profile of an outer side surface of the neck has, along the longitudinal axis, a central concave stretch between two convex end stretches; wherein an annular outer groove is made in an end stretch of said two convex end stretches of the neck, proximal to the tubular body, and is suitable for inserting a gripper for handling the preform.

12. The preform according to claim 1, wherein a lower surface of the neck is a flat surface.

13. The preform according to claim 1, wherein a center of gravity of the preform is along the longitudinal axis X at a distance, from a flat annular surface of a mouth or opening of the neck, that is comprised in a range from 85 to 95 mm; wherein a weight of the preform is comprised in a range from 80 to 100 grams.

14. An injection mold for producing preforms according to claim 1, said mold comprising a plurality of molding cavities,
wherein each molding cavity is defined by a cooperation of a male component, or core insert, and a female component comprising a neck insert, or neck ring, a cavity insert, and a gate insert;
wherein said neck insert extends along a longitudinal axis of the molding cavity so as to cover a first longitudinal portion of the molding cavity corresponding to a zone of the preform including
both the neck, having an inner diameter D0 that is greater than or equal to 17 mm, and a thickness varying along the longitudinal axis and with a minimum value of at least 4 mm,
and the first portion of the tubular body, having a substantially cylindrical shape and a length along the longitudinal axis of at least 30 mm, and the second portion of the tubular body having a length along the longitudinal axis of at least 20 mm and wherein the respective outer diameter gradually increases with a truncated-cone shaped profile from the value D1 to the value D2;
wherein said neck insert is provided, at two ends along said longitudinal axis, with a first truncated-cone shaped projection and a second truncated-cone shaped projection, respectively;
wherein there is provided a first locking element for locking together the male component and the neck insert, said first locking element abutting at least with a truncated-cone shaped side surface of said first truncated-cone shaped projection;
wherein there is provided a second locking element for locking together the neck insert and the cavity insert, said second locking element abutting with a truncated-cone shaped side surface of said second truncated-cone shaped projection;
wherein a length H1 of the first truncated-cone shaped projection and a length H2 of the second truncated-cone shaped projection, both measured along said longitudinal axis, satisfy the following relationship
H1+H2≥0.2*H
where H is a length, measured along said longitudinal axis, between a flat annular surface of the molding cavity, corresponding to a surface of a mouth of the preform, and a separation plane between the neck insert and the cavity insert.

15. The injection mold according to claim 14, wherein there is provided a plurality of cooling channels inside the neck insert, arranged along a second longitudinal portion of the molding cavity corresponding to a zone of the preform including the neck and at least the first portion of the tubular body; wherein the cooling channels are present along at least 70% of part of an outer profile of the first longitudinal portion of the molding cavity corresponding to a zone of the preform including both the neck and the first portion and the second portion of the tubular body.

16. The injection mold according to claim 15, wherein, at a molding cavity portion corresponding to the neck of the preform, there is provided at least one cooling channel at a distance of less than or equal to 5 mm, at a distance from 2 to 3 mm, from an outer surface of said molding cavity portion corresponding to the neck of the preform.

17. The injection mold according to claim 14, wherein each molding cavity has a shape substantially corresponding to a final shape of a preform according to claim 1.
